(19) United States
(12) Patent Application Publication
(10) Pub. No.: US 2004/0206210 A1
(43) Pub. Date: Oct. 21, 2004

(54) Combination tool system for changing multi-tube fluorescent light bulbs

(76) Inventor: Anthony Frank Tryba, Biloxi, MS (US)

Correspondence Address: MARK O. LOFTIN, 1990 BRADSHIRE DR., MOBILE, AL, 36695, US

(21) Appl. No.: 10/414,560

(22) Filed: Apr. 15, 2003

(51) Int. Cl. B25B 23/16

(52) U.S. Cl. 81/53.1

(57) ABSTRACT

The present invention provides a combination tool system that can be used to change a variety of multi-tube, compact fluorescent light bulbs installed in light sockets that are located in relatively inaccessible areas. This tool system is comprised of a tool end, handle end and non-conductive coupling means. The tool end is square-shaped to fit around the glass tubes of common fluorescent light bulbs. The tool system also includes a series of removable inserts placed into the square-shaped tool end that is designed to adapt the tool to other non-square glass tube arrangements or tubes of smaller cross sectional diameter. An additional insert is also provided with a plurality of prongs projecting upwardly that is pushed into the base of the broken light bulb to grip the socket base while the user turns the handle.

### BACKGROUND OF INVENTION

This invention generally relates to the field of special tools, called light bulb changers, designed to aid in the retrieval and replacement of used light bulbs from light sockets located in relatively inaccessible places. These type combination tools are generally comprised of either a variable or fixed length handle end, a tool end, and a non-conducting coupling means to attach the tool end to the handle end and to insulate the user from the voltage present in the light socket. The design of the handle end is well known in the art and is generally based on requirements such as length, reaching angle, turning torque and ergonomics. These handles can be either fixed-length, extendable by means of internally sliding members or extendable by connecting a plurality of other fixed-length handle sections. The non-conducting coupling means is also generally well known in the art and may be permanently attached to the handle end or comprised of a quick-disconnecting type coupling such that more than one tool end can be connected to the handle end.

The tool end contains the most significant degree of variation because of variety in size and shape of commercially available light bulbs. The design of the tool end is based primarily on the need to securely hold a light bulb so that it can be safely manipulated by the user in the removal and replacement of light bulbs. The typical manipulations include raising the light bulb to and lowering the light bulb from the light socket and rotating the light bulb into or out of the threaded base of the light socket. In both commercial and residential structures, light sockets are typically located in the ceiling areas. Since most ceilings heights render light sockets inaccessible to the unaided hand, removal and replacement of most light bulbs necessarily requires the use of either a platform or ladder to elevate the user to the light socket or a tool that extends the reach of the user up to the light socket. The use of a platform or ladder to elevate the user is generally less preferred since platforms can be bulky, require significant set-up time and may not be usable where obstructions prevent access to the floor area directly below or near the light socket. Also, platforms may create fall hazards that could result in injury to the user.

The generally preferred means of changing inaccessible light bulbs is by means of an extension tool, such as that provided by this invention. These types of changers are preferred because they are cheaper to manufacture, easier to store when not in use, quicker to set-up and use, and allow the user to reach around obstructions. Extension tools also provide a means to engage the light bulb at a safe distance to avoid contacting the potentially hot surfaces of the light bulb and the voltage that may be present.

The most common type of tool ends available today are spring-clip type, suction cup type and broken-bulb type. The spring-clip changers have a plurality of bands, coated in a non-conducting, flexible material, that are connected at one end to the coupling means and at the other to a spring that forms a stretchable circle. When the user pushes the spring-clip tool against the light bulb, the spring stretches around the curved surface of the bulb and allows the bulb to enter the inner cavity formed by the plurality of bands. The tension created by the bands and the spring against the surface of the light bulb and the friction of the non-conducting material sliding against the light bulb surface are designed to provide sufficient gripping strength such that the user can turn the bulb into or out of its socket threads. The problem with this type of design is that the gripping strength is often insufficient to withstand the torque applied by the user to remove snuggly-fit light bulbs. Also, this type of design is not effective where the light bulb does not have a smoothly curved outer surface.

Suction-cup type changers employ a tool end that is comprised of a circular, concave piece of rubber that is pressed against the light bulb such that the a vacuum is formed between the underside of the rubber piece and the surface of the light bulb. This vacuum provides the attaching means necessary to grip the light bulb. Although this type of tool allows for greater torque to be applied to the light bulb without slipping, it requires a broad, round shape of the light bulb to be effective. This requirement limits the utility of this type tool end for many commercially available bulb types. Also, over time, the periodic heating and aging of the rubber gradually degrades its resiliency, which renders it ability to produce a vacuum against the light bulb surface ineffectual and replacement is necessary.

The broken-bulb type tool end is used solely to remove a light bulb that has had its outer glass surface shattered such that the metal base is the only area to which a tool can be attached to remove the broken bulb from its threaded light socket. This type typically employs a tool that wedges into the metal base of the light bulb using an upward force applied by the user. This type may also include a collection tray just below the wedge to collect any debris which may fall from the broken bulb during the removal process. However, since the tool end for removing broken bulbs is markedly different that those for removing intact bulbs, users are often required to purchase a separate tool and handle assembly specifically for broken bulbs, which significantly increases the costs of a complete set light-changing tools.

What is needed in the art is a type of light bulb changer that can apply as much torque as can be withstood by the light bulb without slipping and is comprised of materials that will not degrade over time or due to heat exposure. What is also needed in the art is a type of light bulb changer that can be used to grip triple and quad tube type energy-saving, compact fluorescent light bulbs. These type bulbs are becoming much more commonly used by businesses which have extensive lighting systems because they last longer, provide better quality light, provide higher light output for their size and use less electricity. Presently, there does not exist in the art a changer that has these characteristics and is usable for these type of light bulbs. What is also needed is a tool end design that can accommodate a series of inserts which be quickly added to allow the user to adapt the tool to the range of light bulb sizes and types, either broken or intact, without the need for multiple tool-handle combinations. The inventor presents such tool system here.

### SUMMARY OF INVENTION

The deficiencies in the prior art, as described above, are solved by the present invention. That is to say, the present invention provides a combination tool system that can be used to change a variety of multi-tube, compact fluorescent light bulbs installed in light sockets that are located in relatively inaccessible areas. This tool system is comprised of a basic tool frame assembly and a series of removable inserts designed to adapt the tool frame assembly to a variety of triple-tube or quad-tube type compact fluorescent light bulbs. An additional insert is provided to allow removal of these type bulbs in the event they are broken while secured inside a threaded light socket. The basic tool frame assembly is comprised of a handle that can either be of fixed or variable length, a light-engaging end that securely receives a light bulb, an insert which aids in securing the light-engaging end to the light bulb's shape, and a non-conducting means for connecting the light-engaging end to the handle. The light-engaging end is comprised of a thin, yet sturdy, strip of material bent into a u-shape. The length of the sides of the u-shaped member can vary depending on the length of the glass tubes that comprise the multi-tube compact fluorescent light bulb. Each end of this u-shaped member is attached to the bottom side of a second strip of material that is formed into a square. The length and width dimensions of the square-shaped member can vary but are generally large enough to fit around the largest size compact fluorescent light bulbs presently on the market. A hole is drilled at the base of this u-shaped member for receiving a fastening means, such as a bolt, nut and washer, which is used to secure the base of the u-shaped member to the handle. This method of securing the u-shaped member to the handle coupling means allows it to be quickly removed in the event other light changing tool ends are developed in the future. A non-conducting attaching means is also provided for connecting the handle to the u-shaped member. This attaching means is comprised of a cylindrically shaped object having an internal void space for receiving a circular-shaped handle. The diameter of this void space closely approximates the outside diameter of the circular-shaped handle such that it fits securely when inserted into the void space. Another embodiment includes securing the handle to the non-conducting coupling means using a plurality of fasteners. In the preferred embodiment of this tool system, three attachments are provided that are inserted into the square-shaped member to accommodate light bulbs of smaller and non-square outer shape. Two of these inserts are used to fit variations of compact fluorescent light bulbs. One other insert is designed to be used when a broken bulb is encountered such that the glass section of the bulb is not present or is not otherwise capable of being securely gripped during the twisting motion required to remove it from the light socket.

### BRIEF DESCRIPTION OF DRAWINGS

FIG. 1 shows a side view of the basic tool assembly comprising the handle, light-engaging end and coupling means.

FIG. 2 is a partial, sectional side elevational view showing the light-engaging end and the top part of the coupling means in more detail.

FIG. 3 shows a side elevational view of one type of triple-tube compact fluorescent light bulb as it appears inserted into the light-engaging end, which also has one of the inserts for this type light bulb also inserted.

FIG. 4 shows a side elevational view of a typical quad-tube compact fluorescent light bulb and an insert as it appears engaged into the tool end of this invention.

FIG. 5 shows a three-dimensional view of the insert for use with triple-tube or quad-tube compact fluorescent light bulbs.

FIG. 6 shows a three-dimensional view of the insert for use with another smaller type of triple-tube compact fluorescent light bulb.

FIG. 7 shows a three-dimensional view of the insert for use with any type of compact fluorescent light bulb where the glass tubes are broken.

### DETAILED DESCRIPTION

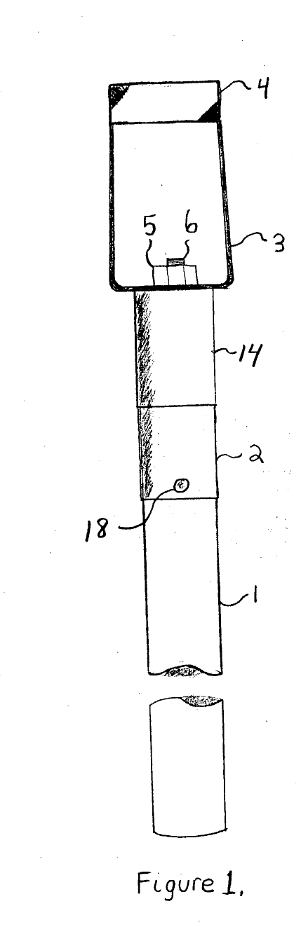

As best shown in FIG. 1, the basic tool system is comprised of a handle 1, a light-engaging end comprised of a u-shaped member 3 and a square-shaped member 4, and a non-conductive coupling means 2 and 14. A fastener shown as a nut 5 and bolt 6 are used to connect the light-engaging end to the coupling means. The handle 1 is generally well known in the art and can be a round-shaped object made of any material that is sufficiently inflexible so that it will not bend under its own weight or that of the attached light-engaging end. Certain types of telescoping handles are known in the art and can be easily adapted for use in the tool system provided here. The inventor presents the simplest embodiment of this handle, which is a round solid pole of fixed length. This length is dependent on the distance that must be reached by the user.

The light-engaging end is comprised of a u-shaped member 3 that can be made out of a thin strip of sheet metal bent to a u-shape or formed from a moldable plastic. The sides of this u-shaped member are approximately equal. At the top of each side piece of the u-shaped member is attached a second strip of material 4 bent to form a square. The upwardly pointing sides of the u-shaped member are attached to the bottom edge of the square-shaped member 4 at two opposite sides. The inside dimensions of the square-shaped member depend on the largest size of compact fluorescent light bulbs presently available. The inventor's preferred embodiment specifies the inside dimensions of the square-shaped member from 2 to 2-½ inches.

At the base of the u-shaped member 3, a hole is drilled to receive a fastening means 5 and 6. This means of attaching the light engaging assembly to the handle coupling member 2 is preferred because it allows for easy removal to accommodate a range of other light engaging attachments that may be developed in the future by the inventor or others. Alternatively, this type of attachment means is useful to accommodate a variety of handle types. However, is it contemplated by the inventor that this type of fastening means is not required and the light-engaging end can be permanently attached to the coupling means 2 or fastened by means other than a nut and bolt, such as a quick-disconnect fitting.

In continued reference to FIG. 1, a coupling means 2 and 14 is shown which is designed to strengthen the connection between light-engaging end and the handle and to provide a non-conductive material to prevent electrical voltage from being transferred from the light socket to the handle. This means is comprised essentially of two a hollow cylinders. One cylinder 2 is of diameter closely approximating the diameter of the handle 1. The cylinder 2 is attached on one end to a second cylinder 14, which is of slightly larger diameter, not exceeding the outside diameter of the first cylinder. In the inventor's embodiment, the handle 1 is inserted into the axial void space of cylinders 2 and 14. Into the axial end of the handle, a threaded bolt is install which extends axially upward and through the hole in the base of the u-shaped member 3. When fasteners 5 and 6 are tightened, the light-engaging end is securely attached to the handle. However, it is to be understood that several methods of attaching the light-engaging end to the handle can be employed by one skilled in the art and that the inventor presents one such preferred means herein. A hole 18 is also shown drilled into the bottom section 2 of the coupling means to receive a ball or cylinder-type object which can be built into the handle and used to lock the coupling means in place and secure it to the handle. This is one method of a quick-disconnect type fitting to hold the coupling means to the handle.

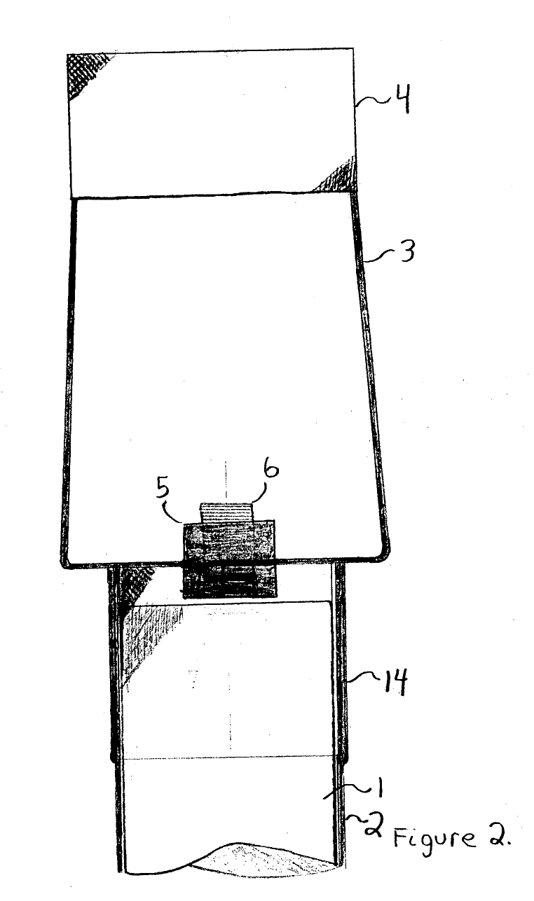

In reference to FIG. 2, more detail is shown regarding one means for fastening the light-engaging end to a circular handle 1. In this embodiment, a threaded bolt 6 is inserted through a hole in the top section 14 of the coupling means and through a hole drilled into the base of the u-shaped member 3. A nut 5 is fastened onto the bolt and tightened to hold the light-engaging end to the handle. An alternate means of securing the handle to the light-engaging end could be to insert a threaded sleeve into the axial end of the handle. One end of a threaded stud could be screwed into this threaded sleeve and the handle-stud combination inserted into the coupling means, through the hole in the base of the u-shaped member and secured using a nut.

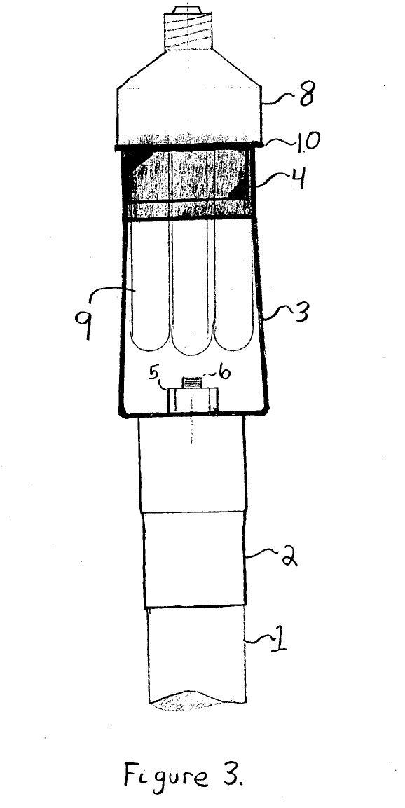

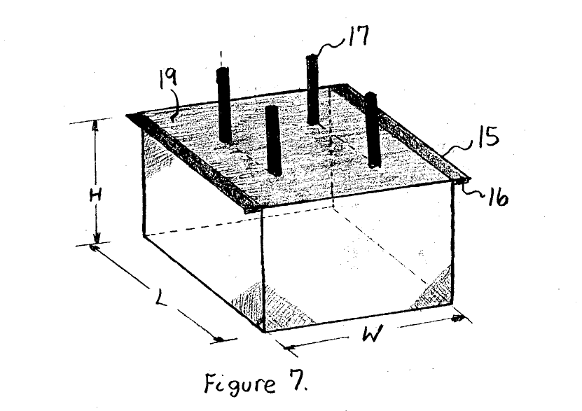

In reference to FIG. 3, we see the light-engaging end as it would appear with one type of triple-tube compact fluorescent light bulb 8 with the rounded glass tubes 9 inserted and extending downward into the inner cavity of the light-engaging end. Since different types of the compact fluorescent light bulbs have different shapes and overall dimensions, the width of the square member 4 is made larger than the largest type of bulb available. To ensure a snug fit for light bulbs of different size or shape, an insert device, such as 10 is placed into the inner portion of the square member 4. For light bulbs where the glass tubes are arranged to form a substantially square outer shape, the inside shape of the insert is also substantially square to fit around the tubes. For light bulbs where the tubes are arranged to form a substantially triangular outer surface, an insert with a pentagon-shaped inner surface is provided (see FIG. 6).

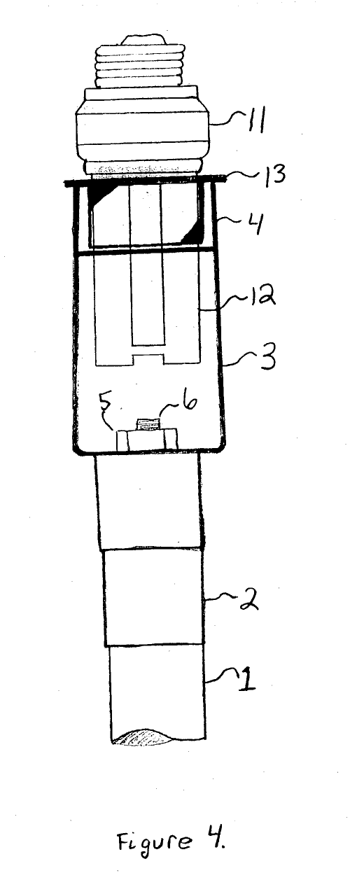

FIG. 4 demonstrates the adaptability of this tool system to a significantly different shaped light bulb, such as the quad-tube design, with base 11 and glass tubes 12 extending downward into the inner cavity of the light-engaging end. For this light bulb, an insert 13 of slightly different dimensions is employed.

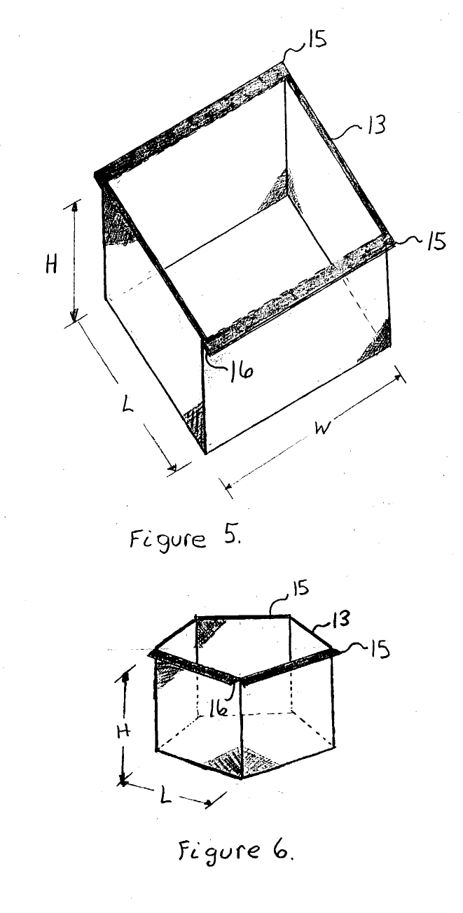

FIG. 5 shows one of the inserts used in this tool system that is applicable to both quad tube and triple-tube light bulbs which have a square outer shape. The insert 13 is held in place by the force of gravity along a rim 15 extending along the top portion of two sides of the insert. The underside of the rim 16 rests on the top edge of the square-member 4 shown in FIGS. 1 through 4. In the preferred embodiment, the length L, width W, and height H are approximately 1-¾″×1-¾″×1″ respectively. However, the inventor contemplates that these dimensions could vary depending on the type of light bulbs that may be available in the future.

FIG. 6 shows a second insert used in the tool system that is applicable to triple-tube light bulbs where the tubes are positioned in a rounded triangular pattern. To accommodate this shape, the sides of the insert 13 are formed into a pentagon. To hold this insert into the square-shaped member 4, rims 15, are placed on the top of two adjacent side of the pentagon-shaped insert.

FIG. 7 shows an additional insert to be used when the glass tubes of the light bulb are broken or cracked. When this happens, the other inserts are ineffective since the torque applied to remove or insert the light bulb into the light socket is applied directly to the glass tubes. When they are not present or are partially broken, some other means is required to apply torque to the base of the bulb to remove it from the light socket. The insert shown in FIG. 8 accomplishes this task by providing 4 prongs 17 in a substantially square pattern about the center of the insert projecting upward from a flat top surface 19. The insert is held in place by rims 15 along two opposite sides that rest on square member 4 on the underside surface of the rims at 16. The user inserts the prongs into the base of the broken bulb with a slight upward pressure applied. When the user twists the handle of the tool system, the prongs grasp remaining fragments of glass or wire extending downward from the base and torque is applied to the base to loosen it from its light socket.

While the preferred embodiments of the invention have been described above, it will be recognized and understood that various modifications may be readily discemable to those skilled in the art and it is not desired to limit the invention to the exact construction and operation shown and described. Accordingly, all suitable modifications and equivalents may be regarded as falling within the scope of the invention as defined by the claims that follow.

Having described this invention with the particularity set forth in this specification, what is claimed is:

1. A combination tool system for changing light bulbs comprising:
an rigid elongated handle;
a light bulb engaging member employing a square-shaped upper piece connected to a u-shaped lower piece in a manner which forms a cavity that can be positioned around the glass tubes of the light bulb,
a non-conductive coupling means for adjoining said handle to said light bulb engaging member,
a removable insert member which is shaped to conform substantially to the outer shape of a light bulb and is placed into the inside cavity of the square-shaped upper piece.

2. The combination tool of claim 1 further comprising a removable insert having a square-shaped outer surface and a square-shaped inner surface that is placed into the square-shaped upper piece to effectively adapt the tool system to light bulbs having glass tubes with a substantially square cross-section and of a substantially smaller width than the inside width of the square-shaped upper piece.

3. The combination tool of claim 1 further comprising a removable insert having a polygonal-shaped outer surface and a polygonal-shaped inner surface that is placed into the square-shaped upper piece to effectively adapt the tool system to light bulbs having glass tubes with a substantially rounded triangular cross-section and of a smaller overall diameter than the inside width of the square-shaped upper piece.

4. The removable insert of claim 3 where the polygonal shape is a pentagon.

5. The combination tool of claim 1 further comprising a removable insert having a square-shaped outer surface and a flat top surface fitted with a plurality of prongs projecting upwardly from said top surface that is placed into the square-shaped upper piece to effectively adapt the tool system to remove broken or damaged light bulbs from their sockets.

6. The combination tool of claim 1 further comprising a rigid telescoping handle that provides a means of adjusting the length of the handle to improve the range of use of the tool.

7. The combination tool of claim 1 further comprising a rigid handle which includes a section that is angularly adjustable to allow the user to engage a light bulb from a direction other than substantially axial to the light socket.
